(19) United States
(12) Patent Application Publication
(10) Pub. No.: US 2012/0092254 A1
(43) Pub. Date: Apr. 19, 2012

(54) PROXIMITY SENSOR WITH MOTION DETECTION

(76) Inventors: Chee Heng Wong, Singapore (SG); Han Kang Chong, Singapore (SG); Yufeng Yao, Singapore (SG)

(21) Appl. No.: 12/904,883

(22) Filed: Oct. 14, 2010

(51) Int. Cl. G06F 3/033; G01P 13/00

(52) U.S. Cl. 345/158; 250/214 R

(57) ABSTRACT

A proximity sensor with movement detection is provided. The proximity sensor may provide a navigation function in response to movement of an object. The proximity sensor includes a driver operable to generate a current to a plurality of light sources in a particular timing sequence, a photo detector configured to receive light and generate an output signal, a controller configured to report the movement of an object near the proximity sensor if the output signal pattern generated matches one of the output signal patterns from among a set of known output signal patterns. The proximity sensor may be configured to provide a navigation operation when an object moves near the proximity sensor.

### BACKGROUND

Proximity sensors are conventionally used to detect the presence of an object without any physical contact. A typical proximity sensor comprises a light source to emit light and a photo detector to detect light reflected by an object that is within a predetermined proximity of the sensor.

Proximity sensors have been widely used in many devices, for example, in a water faucet, the proximity sensor is employed to automatically turn the water on and off when an object, such as a person's hand, is detected within a predetermined distance of the water faucet. The proximity sensor is also commonly used as an electronic switch to open and close an electrical circuit when an object is detected by the sensor. In an automated production assembly line, proximity sensors are used to measure the position of a machine component in the production line. Whereas in the robotics industry; the proximity sensor may be used to monitor a robot's position and control the movements of the robot. More recently, optical proximity sensors have been widely employed in portable electronic devices, such as a portable handheld device, mobile phone and portable computers.

In general, a proximity sensor comprises an invisible light source and a photo detector. When an object comes within a predetermined distance of the sensor, the object reflects the light from the light source toward the photo detector. After sensing the reflected light, the photo detector subsequently sends an output signal, indicating the presence of an object. Typically, an action is performed in response to the output signal, such as turning on water, opening a door, etc. Thus, the conventional proximity sensors are utilized merely to facilitate the detection of an object within a predetermined proximity of the sensor. Despite the ability to detect objects without any physical contact, conventional proximity sensors are not utilized as part of an input function or a navigation operation. Thus, the use of proximity sensors in electronic devices has heretofore been limited to merely performing the dedicated function of proximity sensing.

Therefore, in order to provide an input navigation operation, a dedicated input device is routinely integrated into an electronic device, along with a proximity sensor; which increases the cost. Having an input navigation system and a proximity sensing system necessarily increases the overall size of the device, as more space is needed to accommodate two separate systems. Accordingly, it would be desirable to provide a single device or system that is functionally capable of providing proximity sensing operations, as well as input navigation control operations.

### BRIEF DESCRIPTION OF THE DRAWINGS

Throughout the description and figures, similar reference numbers may be used to identify similar elements.

FIG. 1 illustrates a schematic block diagram of a proximity sensor with movement detection;

FIG. 2A illustrates a schematic diagram of a proximity sensor with movement detection;

FIG. 2B illustrates a top perspective view of a proximity sensor with movement detection;

FIG. 2C illustrates a top view of a proximity sensor with movement detection;

FIG. 3 illustrates a block diagram of a method for movement detection;

FIG. 4 illustrates wave diagrams of output signal patterns representing the detection of a movement of an object from LED X₁-LED X₂; and

FIG. 5 illustrates a schematic block diagram of a proximity sensor with navigation function.

### DETAILED DESCRIPTION

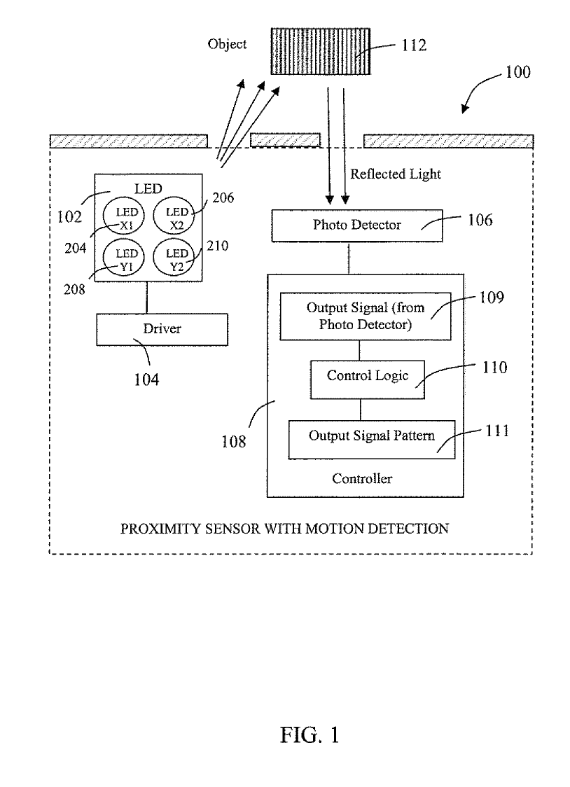

FIG. 1 illustrates a schematic block diagram of one embodiment of a proximity sensor with movement detection 100. The proximity sensor 100 and corresponding movement detection function for providing navigation operation are described in more detail below. Although only the implementation of X-Y input functions are discussed for the proximity sensor 100, other input functions, such as scrolling or mouse clicking event may also be provided by the proximity sensor 100. Although certain component parts are shown in conjunction with the proximity sensor 100 with movement detection of FIG. 1, other embodiments may implement fewer or more component parts for providing a similar detection function.

The proximity sensor 100 may include a plurality of light sources or LEDs 102, a driver 104, a photo detector 106, a controller 108 and control logic 110. In one embodiment, the proximity sensor 100 may be implemented as a modular system, whereby the LEDs 102, the photo detector 106, the controller 108 and the control logic 110 may be integrated under a single package as a module. In addition, the controller 108 and the control logic 110 may form part of an ASIC chip coupled with the photo detector 106.

The proximity sensor 100 may include a plurality of LEDs 102 to emit light and a driver 104 coupled to each LED 102, configured to generate a drive current with a predetermined timing sequence. In one embodiment, the LED 102 may be configured to emit light in response to an applied current having a particular timing or under a certain sequence. The LED 102 may be any suitable source of infrared (IR) LED, which is capable of emitting light at a desirable wavelength and intensity. The selection of the LED 102 may vary depending on the application; and also on its ability to provide the required intensity in producing an optimum light reflection on to the photo detector 106. In one embodiment, the light source may be an infrared LED.

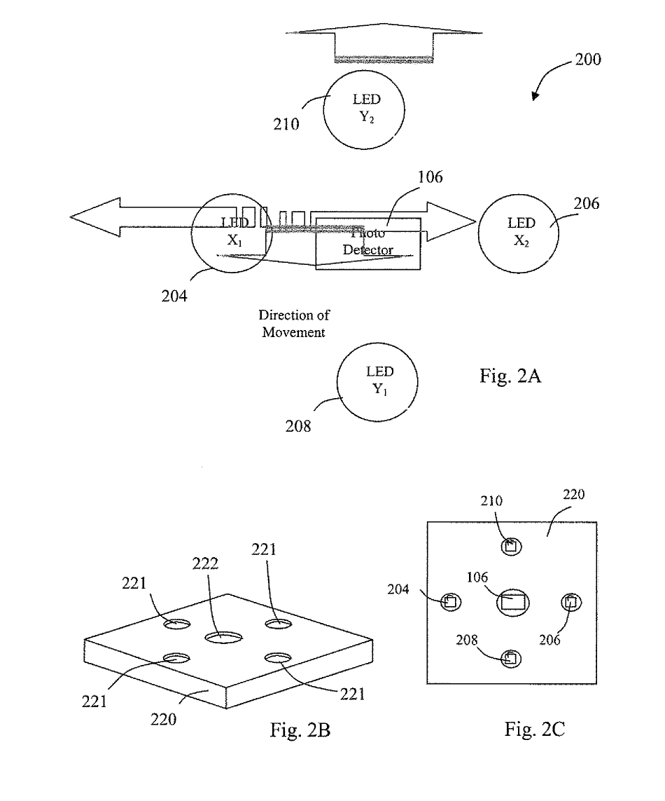

In another embodiment, the proximity sensor 200 may include four infrared LEDs 204, 206, 208 and 210, namely X₁, X₂, Y₁ and Y₂, as illustrated in FIG. 2A. FIG. 2B and FIG. 2C, respectively, which illustrate a top perspective view and top view of a proximity sensor 200 with movement detection. As shown in FIGS. 213 and 2C, the proximity sensor 200 may include a cover 220 disposed over and covering both the photo detector 106 and LEDs 204-210. In one embodiment, the proximity sensor 200 may include a cover 220 made of a mold compound disposed over both the photo detector 106 and LEDs 102 by any known molding process. The cover 220 may include a plurality of LED apertures 221 above each of the LEDs 204-210 and a photo detector aperture 222 over the photo detector 106, respectively. The light emitted by the LEDs 204-210 may pass through the LED apertures 221 towards the object (not shown) to be detected. After the light is reflected by an object (not shown) in close proximity with the proximity sensor 200, it may subsequently pass through the photo detector aperture 222 towards the photo detector 106, where it may be detected. Although the arrows in FIG. 2A illustrate the direction of movement of an object as moving directly between the LEDs, other directions of movement that are more diagonal in nature are also able to be detected, as the light detected from one LED or another will be stronger or weaker.

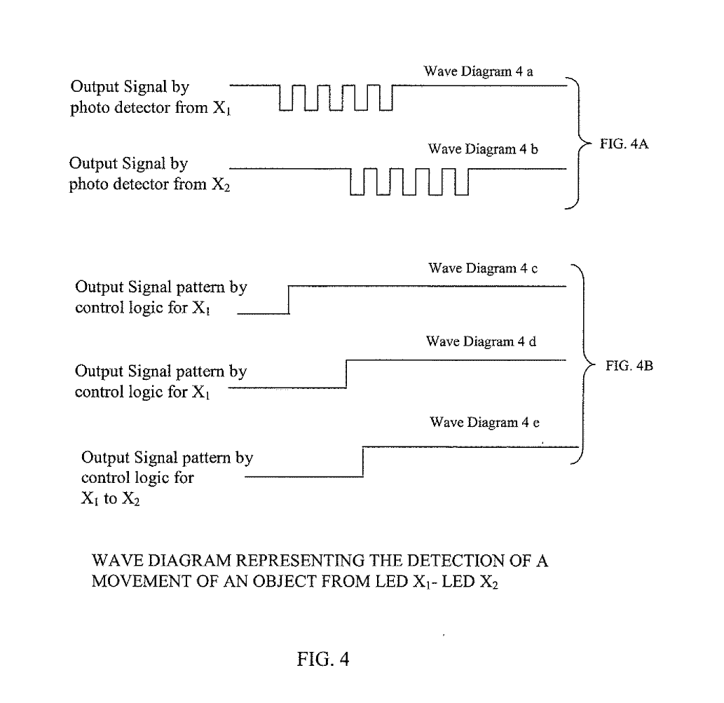

The driver 104 (shown in FIG. 1) may be configured to provide current to each of the LEDs 204-210 in a predetermined sequence, for example, the driver 104 may provide current to X₁ 204 first followed by X₂ 206 and subsequently Y₁ 208 followed by Y₂ 210, for a duration of one millisecond (ms) each. Thus, at any given instant in time, only one of the LEDs 204-210 is lit up and enabled for 1 ms. As the LED is configured to emit light with a known characteristic, if there is an object 112 (shown in FIG. 1) nearby to reflect the light back towards the photo detector 106, the photo detector 106 is therefore, expected to subsequently convey a set of output signals 109 exhibiting the same characteristic as well. For example, each LED may have a particular wavelength associated with it, which would than be detected by the photo detector and subsequently output as a signal representative of an LED of that particular wavelength. The multiple LEDs driven in a particular sequence has the effect equivalent to four photodiodes for detecting movement in the X and Y directions. Details of the characterizes for each of the output signals 109 will be discussed in more detail in the faun of wave diagrams under FIG. 4A-4B.

Referring now to FIG. 1, in another embodiment, the proximity sensor 100 may include a photo detector 106 configured to receive light and generate an output signal 109 in response. In general, a photo detector 106 may convert light or electromagnetic radiation that strikes it into a current. For simplicity, throughout this specification, the electromagnetic radiation may be referred to simply as the light and the current generated by the photo detector 106, in response to the light it received may be referred to as the output signal 109. In an operational embodiment, if there is an object 112 placed nearby the proximity sensor 100, the light emitted by the LED 102 may be reflected towards the photo detector 106 causing the photo detector 106 to generate an output signal 109 in response. The output signal 109 may be expected to contain a pattern that is similar to the pattern of the light emitted by the LED 102. Conversely, if there is no object present to reflect the light emitted by the LED 102, the incident light, if any, received by the photo detector 106 may be from other sources, and this leads to the generation of a different or unknown output signal pattern, which may be ignored or canceled subsequently by the system.

In one embodiment, the controller 108 may be coupled with the photo detector 106, configured to receive the output signals 109 from the photo detector 106. The controller 108 may be configured to report a movement of the object 112 upon determining the presence of a specific pattern in the output signal 109 generated by the photo detector 106. Wherein the specific pattern is an output signal pattern among a set of known output signal patterns, which may be generated by the photo detector 106 in response to certain movements of the object 112 over the proximity sensor 100. The controller 108 may further comprise control logic 110 configured to process or convert the output signals 109 generated by the photo detector 106 into output signal patterns 111.

In one embodiment, when the object 112 moves over the proximity sensor 100 in a particular direction, a specific output signal pattern 111 may be produced by the control logic 110 to represent that movement. For example, when the object 112 moves along the X-axis over the proximity sensor 100, the control logic 110 may process the output signals 109 generated by the photo detector 106 and produce a unique output signal pattern 111 in correspondence to that horizontal movement. Hence, a set of output signal patterns 111 may be created in association to various movements of the object 112 over the proximity sensor 100, whereby each movement may be represented by a specific output signal pattern 111.

In one embodiment, the set of output signal patterns 111 may include a horizontal movement output signal pattern, which represents a horizontal movement of an object 112 along the X-axis over the proximity sensor 100, whereas another vertical movement output signal pattern may represent a vertical movement of an object 112 along the Y-axis. Therefore, in a situation when an output signal pattern 111 generated by the control logic 110 matches one of the output signal pattern among the set of known output signal patterns, the associated type of object movement may be immediately identified.

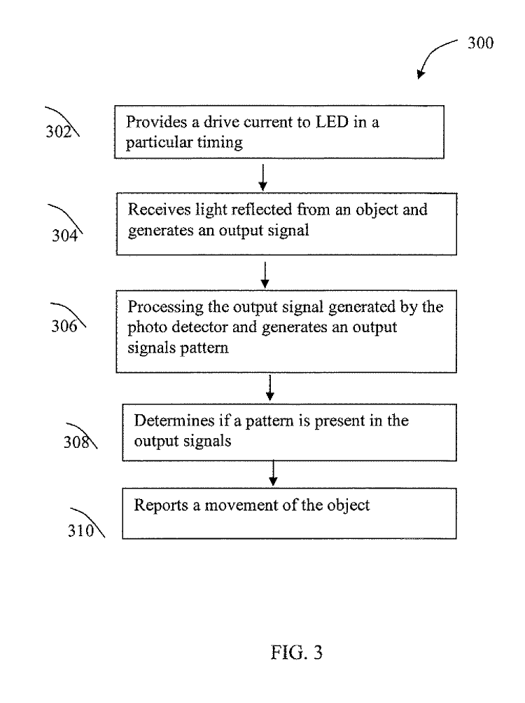

FIG. 3 illustrates a block diagram of one embodiment of a method for movement detection. At block 302, the driver 104 provides a drive current to a LED 102 in a particular timing sequence and causes the LED 102 to emit light with a distinct characteristic. At block 304, the photo detector 106 receives the light reflected from the object 112, if present, and generates an output signal 109 in response to the light received. At block 306, the controller 108, or more specifically, the control logic 110, processes the output signal 109 generated by the photo detector 106 and generates an output signal pattern 111. At block 308, the controller 108 determines if a specific pattern is present in the output signals 111. Wherein the specific pattern is an output signal pattern from among a set of known output signal patterns that is generated by the photo detector 106 in response to certain movements of the object 112 over the proximity sensor 100. At block 310, the controller 108 reports a movement of the object 112 upon determining the presence of a specific pattern in the output signals pattern 111 generated by the control logic 110. Therefore, when the object 112 moves over the proximity sensor 100 in a particular direction, the light generated by the LED 102 may be reflected towards the photo detector 106. Hence the output signal pattern 111 generated may be expected to have a similar pattern as the output signal patterns that represents the particular movement of the object 112.

FIG. 4 illustrates wave diagrams of output signal patterns representing the detection of a movement of an object from LED X₁-LED X₂. The example of a proximity sensor with four infrared LEDs that was previously described in FIG. 2 and the FIG. 1 will be used in conjunction with FIG. 4 for explaining these wave diagrams. In one embodiment, the driver 104 may be configured to provide a current to each of the LED in a sequence to emit light. For example, the driver 104 may be configured to provide a current to LED X₁ 204 first followed by X₂ 206 and subsequently Y₁ 208 followed by Y₂. FIG. 4a shows the wave diagrams representing the output signal 109 generated by the photo detector 106 when an object moves in the horizontal direction over the proximity sensor 100 from LED X₁ 204 to LED X₂ 206. When the object moves from LED X₁ 204 to LED X₂ 206, light emitted by the LEDs may be reflected by the object and strike the photo detector 106, causing the photo detector 106 to generate an output signal 109, as shown in wave diagrams 4a and 4b in FIG. 4A. The control logic 110 may subsequently process these output signals 109 (see wave diagram 4a and 4b), previously generated by the photo detector 106 to produce output signals shown in wave diagrams 4c and 4d in FIG. 4B. The control logic 110 may then combine these output signals and finally generate an output signal pattern 111 representing the horizontal movement of the object over the proximity sensor 100, shown in wave diagram 4e in FIG. 4B.

As discussed previously, in the situation when the output signal pattern 111 generated by the control logic 110 matches one of the output signal patterns from among a set of known output signal patterns, a particular type of object movement can be immediately identified by the proximity sensor 100. Conversely, if there is no object present to reflect the light emitted by the LEDs X₁ 204 and X₂ 206, the incident light, if any, received by the photo detector 106 will be from other sources, such as ambient light. Therefore, the output signal pattern subsequently produced by the control logic 110 will be of a different form, and may be ignored or canceled subsequently.

In another embodiment, the output signal pattern 111 generated by the controller 108 may also represent the movement of an object in other directions. For example, with reference to FIG. 2, the output signal pattern may represent another direction of object movement such as: (a) a horizontal movement of an object in the reverse direction from LED X₂ 206 towards LED X₁ 204; (b) a vertical movement of an object in the direction from LED Y₁ 208 towards LED Y₂ 210; and (c) a vertical movement of an object in the direction from LEDs Y₂ 210 towards LED Y₁ 208.

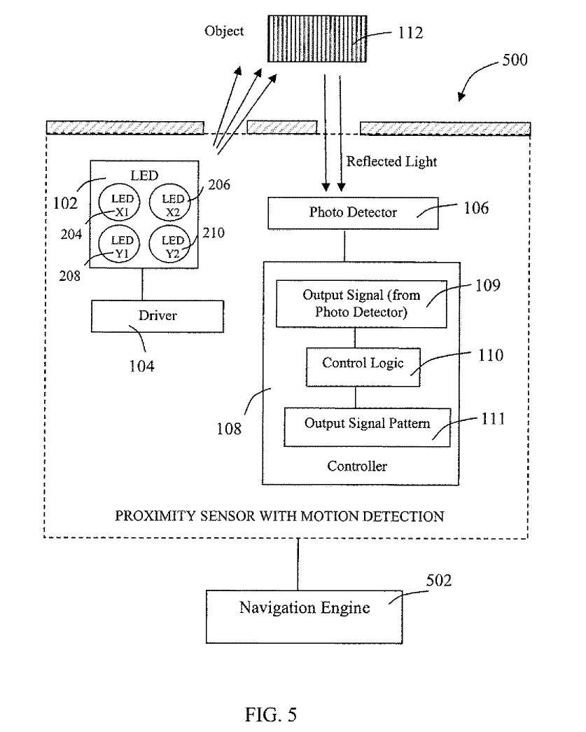

FIG. 5 illustrates a schematic block diagram of one embodiment of a proximity sensor 500 with navigation function. In this embodiment, the proximity sensor 500 may be coupled with a navigation engine 502 configured to provide the navigation operation upon the detection of the movement of an object 110 over the proximity sensor 500. A proximity sensor with movement detection has been discussed with respect to FIG. 1 to FIG. 3. In one embodiment, the proximity sensor 500 with movement detection is coupled with a navigation engine 502 to emulate navigation functions such as a cursor control or a mouse click event. The navigation engine 502 may be configured to provide a navigation operation when a movement has been reported by the proximity sensor 500. For example, when a user makes a horizontal hand gesture over the proximity sensor 500, the hand movement may be detected by the proximity sensor 500 and subsequently used by the navigation engine 502 to emulate navigation functions such as a cursor movement or a mouse click event.

In another embodiment, the proximity sensor 500 with movement detection may be utilized as a touch-less input device configured to provide a navigation function without a physical contact. The proximity sensor 500 may be a portion of an input device coupled to a hand-held portable electronic device to provide a touch-less input function, whereby the proximity sensor 500 is configured to recognize a hand gesture made by the user and use the detected movement to emulate navigation functions such as cursor movement, four way rocker or a mouse click event. In another embodiment, the proximity sensor 500 may be used as a secondary input device to supplement a capacitive based touch sensitive input device. It is known that a capacitive based touch sensitive portable device, for example an i-Pod Touch, needs a direct contact of finger on the touch screen for operation; therefore it is not operable if the user is wearing a glove. Hence, such a limitation may be overcome if a secondary touch-less input device is incorporated therewith. In another embodiment, the proximity sensor 500 may be incorporated into an electronic book reader, for instance an “i-Pad ” or a “NOOK”, in order to provide a touch-less input function for flipping a page while reading by making an appropriate hand gesture over the device.

It should be understood that integration of the proximity sensor 500 with a navigation engine 502 can be extended beyond the application as an input device. In one embodiment, the proximity sensor 500 can be used as an on/off switch for operating a number of devices or perform multiple functions. For example, the on/off switch can be configured to switch on light A upon the detection of a horizontal movement of an object, and switch on light B upon the detection of a vertical movement of an object. In addition, the proximity sensor 500 can be configured to function as a dimmer, whereby the brightness of a light can be adjusted when an user's hand waves slowly over the proximity sensor 500.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A proximity sensor with movement detection comprising:
a plurality of light sources configured to emit light;
a driver configured to provide current to each light source in a particular timing sequence;
a photo detector configured to receive light and generate an output signal; and
a controller configured to report a movement upon determining the presence of a predetermined pattern in the output signals;
wherein the predetermined pattern is an output signal pattern from among a set of known output signal patterns generated by the photo detector in response to particular movements of an object near the proximity sensor.

2. The proximity sensor of claim 1, further comprising control logic coupled to the controller configured to process the output signals from the photo detector and to generate the output signal pattern.

3. The proximity sensor of claim 1, wherein the controller is configured to report the movement of the object over the proximity sensor if the output signal pattern generated by the control logic matches one of the output signal patterns from among a set of known output signal patterns.

4. The proximity sensor of claim 3, wherein the known output signal patterns comprise a horizontal motion output signal pattern corresponding to a movement of an object along an X-axis over the proximity sensor.

5. The proximity sensor of claim 3, wherein the known output signal patterns comprise a vertical motion output signal pattern corresponding to a movement of an object along an Y-axis over the proximity sensor.

6. The proximity sensor of claim 1, wherein the proximity sensor is further configured to provide a navigation operation.

7. The proximity sensor of claim 6, wherein the proximity sensor is coupled with a navigation engine configured to provide the navigation operation upon detection of a movement of an object near the proximity sensor.

8. The proximity sensor of claim 1, wherein the proximity sensor is a touch-less input device configured to provide a navigation function without physical contact.

9. The proximity sensor of claim 8, wherein the proximity sensor is a portion of an input device coupled to an electronic device.

10. The proximity sensor of claim 8, wherein the proximity sensor is a portion of an input device coupled to a hand held portable electronic device.

11. The proximity sensor of claim 1, wherein the controller and the control logic form part of an ASIC chip coupled with the photo detector.

12. A movement detection method for a proximity sensor comprising:
providing a drive current to a light source in a particular timing sequence;
receiving a light reflected from an object near the proximity sensor;
generating an output signal in response to the light received;
determine if a predetermined pattern is present in the output signal; and
reporting a movement of the object over the proximity sensor if a predetermined pattern is present.

13. The method of claim 12, further comprising processing the output signal generated by the photo detector and generating an output signal pattern with control logic.

14. The method of claim 12, further comprising reporting movement of the object near the proximity sensor if the output signal pattern generated by the control logic matches an output signal pattern from among a set of known output signal patterns.

15. The method of claim 14, wherein the set of known output signal patterns comprises a horizontal motion and a vertical motion output signal patterns associated with movements of an object along either an X-axis or a Y-axis near the proximity sensor, respectively.

16. The method of claim 11, further comprising providing a navigation operation upon detection of a movement of an object near the proximity sensor without any physical contact.

17. The method of claim 16, further comprising translating movements made by an object near the proximity sensor to a navigation operation.

18. A proximity sensor with navigation function comprising:
a plurality of light sources configured to emit light;
a driver configured to provide a current to each light source in a particular timing sequence;
a photo detector configured to receive light and generate an output signal;
a controller configured to report a movement upon determining the presence of a predetermined pattern in the output signals; and
a navigation engine coupled to the controller configured to provide a navigation operation upon detection of a movement of an object near the proximity sensor;
wherein the predetermined pattern is an output signal pattern from among a set of known output signal patterns generated by the photo detector in response to a particular movement of an object near the proximity sensor.

19. The proximity sensor of claim 18, further comprising control logic coupled to the controller configured to process the output signals from the photo detector and to generate the output signal pattern.

20. The proximity sensor of claim 18, wherein the controller is configured to report the movement of an object near the proximity sensor if the output signal pattern generated by the control logic matches one of the output signal patterns from among a set of known output signal patterns.
